(19) United States
(12) Patent Application Publication
(10) Pub. No.: US 2014/0271997 A1
(43) Pub. Date: Sep. 18, 2014

(54) METHOD OF EXCHANGING GAS IN A PROCESS OF MAKING OXYGENATED WATER

(71) Applicant: BIYOUNG BIOTECHNOLOGY CO., LTD., Tortola (GB)

(72) Inventors: SHU-FEN LEE, Taipei (TW); CHE-WEI LIN, Kaohsiung (TW); SHIH-MING TUNG, Kaohsiung (TW)

(73) Assignee: BIYOUNG BIOTECHNOLOGY CO., LTD., Tortola (GB)

(21) Appl. No.: 13/796,825

(22) Filed: Mar. 12, 2013

(51) Int. Cl. A23L 2/54

(52) U.S. Cl. CPC A23L 2/54
USPC 426/67

(57) ABSTRACT

A method of exchanging gas in a process of making oxygenated water is performed in a water tank. The water tank has a water inlet, a water outlet, a gas inlet, and a gas outlet. Water is received in the water tank. The water outlet and the gas inlet are closed, and the gas outlet is opened. And then supply the water tank with water through the water inlet to make a water level in the water tank go up and make gas above the water level escape through the gas outlet. Next, close the gas outlet and open the gas inlet and the water outlet once the water tank is almost filled up. Finally, close the gas inlet and the water outlet when the water level is lower than a predetermined level.

### BACKGROUND OF THE INVENTION

1. Technical Field

The present invention relates to drinking water, and more particularly to a method of exchanging gas in a process of making oxygenated water.

2. Description of Related Art

People get sick, and some are caused by lacking of oxygen in cells. Except for breathing, people may get oxygen by drinking oxygenated water. In the present market, the oxygenated water is obtained by pressurizing pure oxygen in a water tank, and waiting for the oxygen being dissolved in water. However, in the pressured water tank, some gases, which are dissolved in the water, will escape from the water. It causes the result that the gas in the water tank no longer is pure oxygen. Therefore, it has to exhaust out the gas in the water tank, and refill with pure oxygen periodically in the process to obtain high oxygenated water.

In the conventional process described above, it needs a large water tank, so that the process can't be applied in a user's house. In addition, it just opens the cover of the water tank to let the gas escape, which is not an efficient way, and furthermore, the exhaustion of the gas is uncontrollable.

### BRIEF SUMMARY OF THE INVENTION

In view of the above, the present invention provides a method of exchanging gas in a process of making oxygenated water, which exchanges gas in an efficient way.

The present invention provides a method of exchanging gas in a process of making oxygenated water. The method is performed in a water tank with water. The water tank has a water inlet, a water outlet, a gas inlet, and a gas outlet, and the gas outlet is on a top of the water tank, and the gas inlet is on a bottom of the water tank. The method includes the following steps:

a). Close the water outlet and the gas inlet, and then open the gas outlet;

b). Supply the water tank with water through the water inlet to make a water level in the water tank go up and make gas above the water level escape through the gas outlet;

c). Close the gas outlet, open the gas inlet to supply the water tank with oxygen, and then open the water outlet to let the water flow out of the water tank and make the water level go down; and

d). Close the gas inlet and the water outlet.

The method of the present invention could increase the efficiency of making the oxygenated water, and exhaust the useless gas out.

### BRIEF DESCRIPTION OF THE SEVERAL VIEWS OF THE DRAWINGS

The present invention will be best understood by referring to the following detailed description of some illustrative embodiments in conjunction with the accompanying drawings, in which:

FIG. 1 is a sketch diagram of the gas-exchanging system of a preferred embodiment of the present invention;

FIG. 2 is a sketch diagram of the water tank of the preferred embodiment of the present invention; and

FIG. 3 is a flowchart of the gas exchanging method of the preferred embodiment of the present invention.

### DETAILED DESCRIPTION OF THE INVENTION

FIG. 1 shows a water tank 10 of a system of making oxygenated water.

The water tank 10 has a water inlet 12, a water outlet 14, a gas inlet 16, and a gas outlet 18.

The water inlet 12 is on a sidewall of the water tank 10, and is adjacent to a top thereof. A water source W is connected to the water inlet 12 of the water tank 10 to supply the water tank 10 with water through a pump 20. The water of the water source W is drinkable, such as RO water. It is preferable that the water of the water source W is low oxygenated water.

The water outlet 14 is on the sidewall of the water tank 10, and is adjacent to a bottom thereof. The high oxygenated water comes out of the water tank 10 through the water outlet 14.

The gas inlet 16 is on the bottom of the water tank 10. An oxygen supplier is connected to the gas inlet 16. In an embodiment, the oxygen supplier is an oxygen cylinder 30. Pure oxygen of the oxygen cylinder 30 enters the water tank 10 through the gas inlet 16 and gets dissolved in the water. It may obtain oxygenated water with higher concentration of dissolved oxygen if the pure oxygen from the oxygen cylinder 30 has longer time to contact with water.

The gas outlet 18 is on the top of the water tank 10 for the gas in the water tank 10 to escape.

In order to extend the time for the pure oxygen being dissolved in the water, the water tank 10 is provided with a postponing device to extend the time for the oxygen staying in the water tank 10. As shown in FIG. 2, the postponing device has a plurality of plates 19 transversely mounted in the water tank 10. The plates 19 respectively have an opening T, and the openings T are alternately on the left and right of the plates 19, so that a continuous S-shaped passageway is formed in the water tank 10. Each plate 19 is wave-shaped, so that each plate 19 has a plurality of exchanging rooms 19a thereunder. Oxygen may stay in the exchanging rooms 19a, and may have a better chance to be dissolved in the water when the Oxygen goes through the continuous S-shaped passageway.

It is noted that any similar design in the water tank 10 to extend the time of the oxygen staying in the water tank 10 should be still in the scope of the present invention.

As shown in FIG. 3, a method of exchanging gas in the process of making oxygenated water includes the following steps:

Close the water outlet 14 and the gas inlet 16 of the water tank 10, and open the gas outlet 18. Start the pump 20 to pump water from the water source W into the water tank 10. As the water being pumped into the water tank 10 via the water inlet 12, it will exhaust out the gas in the water tank 10 through the gas outlet 18.

Just before the water tank 10 being filled up with water, close the water inlet 12 and the gas outlet 18, and open the water outlet 14 and the gas inlet 16. At this time, water will flow out through the water outlet 14, and pure oxygen from the oxygen cylinder 30 will enter the water tank 10 via the gas inlet 16. With the pure oxygen going up and the water level going down, the dissolution ratio of oxygen increases. When the water level goes to a predetermined height, close the water outlet 14 and the gas inlet 16 to complete the oxygen exchanging process. With the pure oxygen going up and the water level going down, and the staying time of the pure oxygen in the water tank 10 being extended by the plates 19, the water obtains higher oxygen content.

In the above steps, the gas escaping out through the gas outlet 18 includes the gases which are originally dissolved in water, such as nitrogen, carbon dioxide, and hydrogen. These gases hinder the dissolution of oxygen, and should be exhausted. In the present invention, these gases are exhausted automatically when the water level changed. It may increase the dissolution ratio of oxygen and obtain higher oxygen content. Besides, the method of the present invention may be performed in a small water tank 10 with a small oxygen cylinder 30, so that users may produce high oxygenated water at home.

In the above embodiment, the gas outlet 18 and the water inlet 12 are closed at the same time when pure oxygen goes into the water tank 10. In an embodiment, the water inlet 12 is opened to supply the water tank 10 with water when pure oxygen goes into the water tank 10. However, the water entering the water tank 10 should be less than the water exhausted out to keep the water level goes down. The water inlet 12 is controllable to adjust a speed of the water level going down.

Instead of closing the water outlet 14 and the gas inlet 16 when the water level goes to a predetermined height, the gas outlet 18 may be closed, and a concentration of oxygen above the water level is under monitoring. While the concentration of oxygen is higher than a predetermined level, the water outlet 14 and the gas inlet 16 should be closed. The level of the concentration of oxygen may vary according to the size of the water tank 10.

The gas exchanging process may be performed under a specified condition. In an embodiment, the gas above the water level is monitored. When the centration of oxygen in the gas is lower than a predetermined level, it indicates that the useless gas (such as nitrogen, carbon dioxide, etc.), and the gas exchanging process will be performed automatically. In an embodiment, a quantity of the water flowing in or flowing out of the water tank 10 is monitored. The water flowing out of the water tank 10 indicates how much oxygenated water is taken out, and the water flowing into the water tank 10 indicates how much water is supplemented to the water tank 10 after the oxygenated water flowing out. A quantity of the water flowing in or flowing out may vary according to the size of the water tank 10.

It must be pointed out that the embodiments described above are only some preferred embodiments of the present invention. All equivalent structures and manufacturing methods which employ the concepts disclosed in this specification and the appended claims should fall within the scope of the present invention.

What is claimed is:

1. A method of exchanging gas in a process of making oxygenated water, wherein the method is performed on a water tank, in which water is received; the water tank has a water inlet, a water outlet, a gas inlet, and a gas outlet; and the gas outlet is on a top of the water tank, and the gas inlet is on a bottom of the water tank; the method comprising the steps of:
a). closing the water outlet and the gas inlet, and opening the gas outlet;
b). supplying the water tank with water through the water inlet to make a water level in the water tank go up and make gas above the water level escape through the gas outlet;
c). closing the gas outlet; opening the gas inlet to supply the water tank with oxygen; and opening the water outlet to let the water flow out of the water tank and make the water level go down; and
d). closing the gas inlet and the water outlet.

2. The method of claim 1, further comprising the step of monitoring a centration of oxygen in the water tank, and performing the step a) only when the centration of oxygen is lower than a predetermined level.

3. The method of claim 1, further comprising the step of monitoring water flowing out of the water tank, and performing the step a) only when the water flowing out of the water tank is higher than a predetermined quantity.

4. The method of claim 1, further comprising the step of monitoring water flowing in the water tank, and performing the step a) only when the water flowing in the water tank is higher than a predetermined quantity.

5. The method of claim 1, further comprising the step of opening the water inlet to supply the water tank with water in the step c).

6. A method of claim 5, wherein the water flowing out of the water tank is greater than the water flowing in the water tank to make the water level go down.

7. The method of claim 1, wherein the water inlet is closed in the step c).

8. The method of claim 1, wherein the step d) is performed only when the water level is lower than a predetermined level.

9. The method of claim 1, further comprising the step of monitoring a centration of oxygen in the water tank, wherein the step d) is performed only when the centration of oxygen is lower than a predetermined level.

10. The method of claim 1, wherein the water tank is provided with a postponing device to extend a time of the oxygen staying in the water tank in the step c).

11. The method of claim 10, wherein the postponing device has a plurality of plates in the water tank, and each of the plates has at least an exchanging room thereunder to receive the oxygen therein.
